(19) United States
(12) Patent Application Publication
(10) Pub. No.: US 2015/0299550 A1
(43) Pub. Date: Oct. 22, 2015

(54) THERMALLY CONDUCTIVE RESIN COMPOSITION

(71) Applicant: PANASONIC CORPORATION, Kadoma-shi, Osaka (JP)

(72) Inventors: Tomokazu KUSUNOKI, Osaka (JP); Yuki KOTANI, Osaka (JP); Hiroyoshi YODEN, Osaka (JP); Tomoaki SAWADA, Osaka (JP); Daizo BABA, Hyogo (JP)

(21) Appl. No.: 14/361,201

(22) PCT Filed: Dec. 26, 2012
(86) PCT No.: PCT/JP2012/084275

§ 371 Date: May 28, 2014

(30) Foreign Application Priority Data
Dec. 27, 2011 (JP) 2011-286481
Aug. 31, 2012 (JP) 2012-191496

(51) Int. Cl. C09K 5/14

(52) U.S. Cl. CPC C09K 5/14

(57) ABSTRACT

The present disclosure is directed to providing a thermally conductive resin composition which can realize high thermal conduction without increasing the content of a thermally conductive filler, and also exhibits satisfactory moldability. Disclosed is a thermally conductive resin composition, comprising:
a thermally conductive filler; and
a binder resin,
wherein the thermally conductive filler contains:
   a hard filler having a Mohs hardness of 5 or more; and
   a soft filler having a Mohs hardness of 3 or less, and
wherein when the thermally conductive resin composition is solidified to stabilize its shape, the soft filler is pressed by the hard filler in the thermally conductive resin composition so that a surface of the soft filler is deformed by the hard filler in the pressed state to provide a face contact between the soft filler and the hard filler.

### TECHNICAL FIELD

The present invention relates to a thermally conductive resin composition which is used in thermally conductive parts such as electronic parts, for example, radiators.

### BACKGROUND ART

Semiconductors of computers (CPUs), transistors, light emitting diodes (LEDs), and the like sometimes cause the generation of heat during use, leading to deterioration of performance of electronic parts due to the heat. Therefore, a radiator is attached to the electronic parts which cause the generation of heat.

Metals with high thermal conductivity have hitherto been used in such radiator, and a thermally conductive resin composition, which exhibits high degree of freedom in selection of shape and is also easy to achieve weight reduction and miniaturization, has recently come into use. It is necessary for such thermally conductive resin composition to contain a large amount of a thermally conductive inorganic filler in a binder resin so as to improve thermal conductivity. However, it has been known that various problems are caused by simply increasing the blending amount of the thermally conductive inorganic filler. For example, an increase in the blending amount causes an increase in viscosity of a resin composition before curing as well as significant deterioration of moldability and workability, resulting in poor molding. There is limitation on a filling amount of a filler, and thermal conductivity is often insufficient (refer to Japanese Unexamined Patent Application Publication Nos. JP 63-10616 A, JP 4-342719 A, JP 4-300914 A, JP 4-211422 A and JP 4-345640 A).

### DISCLOSURE OF THE INVENTION

### Problems to be Solved by the Invention

The present invention has been made in light of the above circumstances, and is directed to providing a thermally conductive resin composition which can realize high thermal conduction without increasing the content of a thermally conductive filler, and also exhibits satisfactory moldability.

### Means for Solving the Problems

The present inventors have intensively studied so as to achieve the above object and found that a thermally conductive filler is formed of a soft filler and a hard filler, and the soft filler is pressed by the hard filler to bring the soft filler into face contact with the hard filler, whereby, larger thermal conduction paths are formed, leading to high thermal conductivity regardless of a small filling amount of the thermally conductive filler. The present inventors have also found that a thermally conductive resin composition containing the thermally conductive filler enables significant improvement in moldability and workability, and thus the present invention has been completed.

That is, the present invention is directed to a thermally conductive resin composition, including:

a thermally conductive filler; and

a binder resin,

wherein the thermally conductive filler contains:
a hard filler having a Mohs hardness of 5 or more; and
a soft filler having a Mohs hardness of 3 or less, and

wherein when the thermally conductive resin composition is solidified to stabilize its shape, the soft filler is pressed by the hard filler in the thermally conductive resin composition so that a surface of the soft filler is deformed by the hard filler in the pressed state to provide a face contact between the soft filler and the hard filler.

In the thermally conductive resin composition according to the present invention, the hard filler may be at least one selected from the group consisting of aluminum oxide, magnesium oxide, fused silica, crystalline silica, aluminum nitride, silicon nitride, silicon carbide and zinc oxide.

In the thermally conductive resin composition according to the present invention, the soft filler may be at least one selected from the group consisting of diatomaceous earth, boron nitride, aluminum hydroxide, magnesium hydroxide, magnesium carbonate, calcium carbonate, talc, kaolin, clay and mica.

In the thermally conductive resin composition according to the present invention, the soft filler may contain a scaly shape, a lamellar shape, a flaky shape or a plate-like shape.

In the thermally conductive resin composition according to the present invention, the total content of the hard filler and the soft filler may be 50% by volume or more and less than 95% by volume based on the whole thermally conductive resin composition.

In the thermally conductive resin composition according to the present invention, a volume ratio of the hard filler to the soft filler may be within a range of the following equation (1),

Hard filler/soft filler=95/5 to 50/50 (1).

The present invention is directed to a thermally conductive molding obtained by molding the above-mentioned thermally conductive resin composition, wherein the soft filler is pressed by the hard filler in the thermally conductive resin composition so that a surface of the soft filler is deformed by the hard filler in the pressed state to provide a face contact between the soft filler and the hard filler.

### Effects of the Invention

According to the present invention, since a soft filler being soft, and a hard filler being hard, are face contacted with each other in a binder resin to efficiently form thermal conduction paths, thermal conductivity becomes satisfactory as compared with the case where the resin contains a hard filler or a soft filler alone therein. The resin contains a soft filler being soft and thus the fluidity of a resin is improved, leading to satisfactory moldability. Furthermore, since the fluidity of the resin is improved, mold wear during molding is reduced, thus enabling a decrease in the frequency of mold displacement.

Therefore, according to the present invention, it is possible to provide a thermally conductive resin composition which can realize high thermal conductivity without increasing the content of a thermally conductive filler, and also has satisfactory moldability.

### BRIEF DESCRIPTION OF THE DRAWINGS

FIG. 1A is a schematic view of a thermally conductive resin composition when using an approximately spherical soft filler, and FIG. 1B is a partially enlarged view thereof.

FIG. 2A is a schematic view of a thermally conductive resin composition when using a plate-like soft filler, and FIG. 2B is a partially enlarged view thereof.

FIG. 3 is a SEM micrograph of a thermally conductive resin composition when using a plate-like soft filler.

FIG. 4A is a conceptual perspective view of an irregularly shaped filler, and FIG. 4B is a bottom view thereof.

FIG. 5 is a schematic view of a thermally conductive resin composition according to the present invention, including, as thermally conductive fillers, an irregularly shaped hard filler and a plate-like soft filler.

FIG. 6A is a schematic view of an existing thermally conductive resin composition, and FIG. 6B is a partially enlarged view thereof.

FIG. 7 is a schematic view of a light emitting device including a radiator made of a thermally conductive resin composition according to the present invention.

### MODE FOR CARRYING OUT THE INVENTION

Mode for carrying out the present invention will be described in detail below with reference to the accompanying drawings. The following embodiment illustrates a thermally conductive resin composition for specifying technical idea of the present invention, and do not limit the present invention. The size, material, shape and relative arrangement of components illustrated in the present embodiment are not intended to limit the scope of the present invention only to these unless otherwise specified, but are merely illustrative. The size and positional relation of members illustrated by the respective drawings are sometimes exaggerated so as to clarify the description.

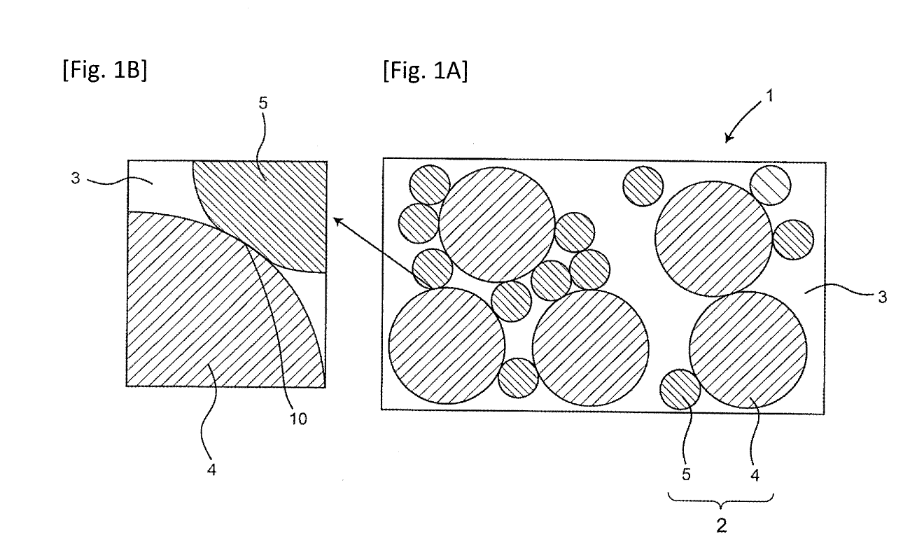

FIG. 1A is a schematic view of a thermally conductive resin composition 1 according to a first embodiment of the present invention, and FIG. 1B is a partially enlarged view thereof. As shown in FIGS. 1A and 1B, the thermally conductive resin composition 1 includes a thermally conductive filler 2 and a binder resin 3, and the thermally conductive filler 2 contains a hard filler having a Mohs hardness of 5 or more (hereinafter referred to as a hard filler or an inorganic hard filler) 4 and a soft filler having a Mohs hardness of 3 or less (hereinafter referred to as a soft filler or an inorganic soft filler) 5.

Therefore, when the thermally conductive resin composition 1 is solidified to stabilize the shape, a surface of the soft filler 5 is deformed by the hard filler 4 in a state where the soft filler 5 is pressed by the hard filler 4 in a structure of the thermally conductive resin composition 1, and thus the hard filler 4 and the soft filler 5 are face contacted with each other. As used herein, face contact means that some object is contacted with some object with face-to-face contact. In the present invention, for example, it means that the hard filler 4 and the soft filler 5 are contacted with each other so that a contact area between the hard filler 4 and the soft filler 5 is from 0.01 μm² to 25 μm², suitably from 0.05 μm² to 10 μm², and more suitably from 0.1 μm² to 5 μm².

Heretofore, thermal conductivity has been imparted to a resin by using a thermally conductive filler alone and filling a resin with a large amount of the thermally conductive filler. However, there is limitation on the filling amount of the thermally conductive filler, and it is difficult to further improve the thermal conductivity of the resin composition by filling with the thermally conductive filler in high density. Filling with the thermally conductive filler in high density may cause drawbacks such as deterioration of moldability and deterioration of mold wear due to decreased fluidity of the resin composition.

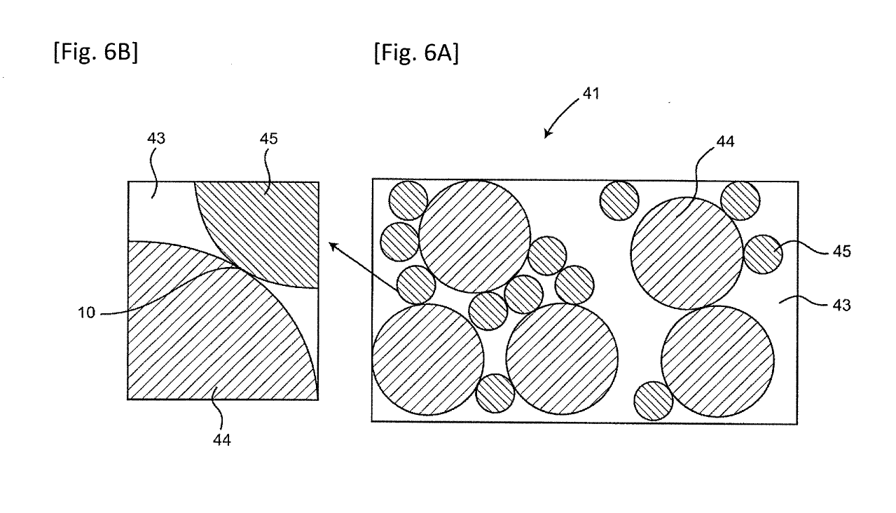

FIG. 6A is a schematic view of an existing thermally conductive resin composition 41, and FIG. 6B is a partially enlarged view thereof. As shown in FIGS. 6A and 6B, if fillers have approximately the same hardness, one filler 45 is less likely to be deformed due to pressing by the other filler 44, and fillers 44 and 45 are point contacted with each other at a contact portion 10. Therefore, in this case, thermal conduction paths have a small path width. In contrast, in the thermally conductive resin composition 1 of the present invention, since the hard filler 4 and the soft filler 5 are used in combination, as shown in FIG. 1B, the soft filler 4 is pressed by the hard filler 5 to cause deformation of the soft filler 5 at the contact portion 10 between the hard filler 4 and the soft filler 5. Whereby, the hard filler 4 is face contacted with the soft filler 5, thus increasing the path width of thermal conduction paths. Therefore, it is possible for the thermally conductive resin composition 1 of the present invention to obtain high thermal conductivity by using the filler in the amount which is the same as or less than that of an existing thermally conductive resin composition, thus enabling an improvement in thermal conductivity. When the soft filler and the hard filler are used in combination, the contact area between the soft filler and the hard filler can be controlled to a contact area which is 1 time to 20 times, more suitably 1.5 times to 10 times, and still more suitably 2 times to 5 times, larger than a contact area between fillers having approximately the same hardness.

The hard filler 4 and/or the soft filler 5 may be either an inorganic substance or an organic substance, and an inorganic substance (that is, an inorganic filler) is used, more suitably.

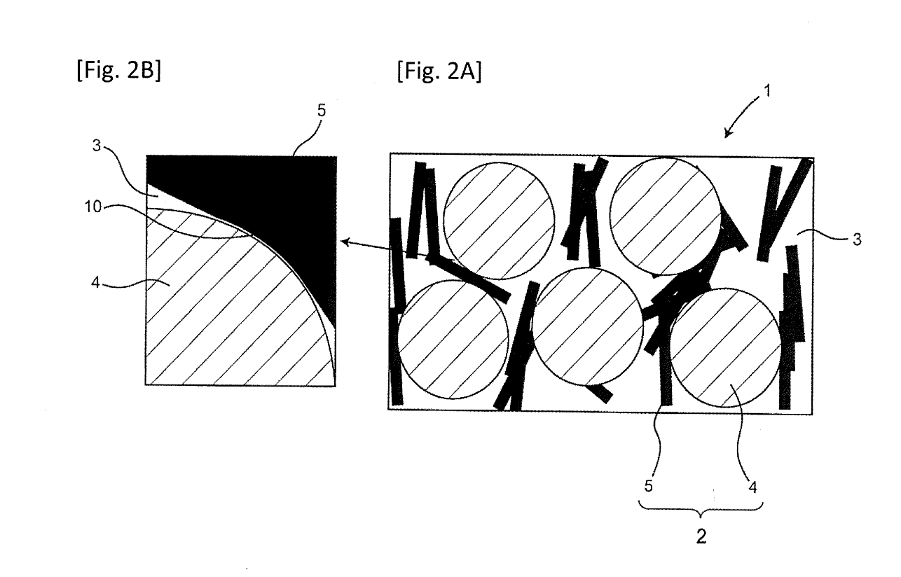

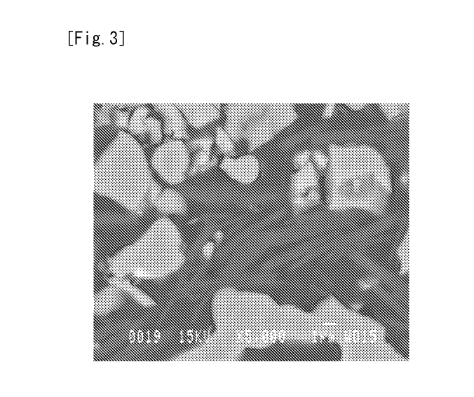

FIG. 2A is a schematic view of a thermally conductive resin composition 1 when using a plate-like one as a soft filler 5, and FIG. 2B is a partially enlarged view thereof. FIG. 3 is a SEM micrograph of a thermally conductive resin composition 1 when using a plate-like one as a soft filler 5.

In a thermally conductive resin composition 1 according to a first embodiment of the present invention, the soft filler 5 may have any shape, suitably a thin walled plate-like shape, and may have so-called scaly shape, lamellar shape, flaky shape, or the like. As mentioned above, when using, as the soft filler 5, a scaly, lamellar, flaky, or plate-like soft filler, as shown in FIG. 2B, the soft filler 5 is pressed by the hard filler 4 and the soft filler 5 is curved at a contact portion 10 between the hard filler 4 and the soft filler 5, and thus a contact area between the soft filler 5 and the hard filler 4 further increases as compared with the case where the soft filler 5 has a spherical shape or a polyhedral shape. Therefore, the thermally conductive resin composition 1 using a scaly, lamellar, flaky, or plate-like soft filler exhibits higher thermal conductivity.

When using the scaly, lamellar, flaky or plate-like soft filler in combination with a spherical hard filler, the contact area between the soft filler and the hard filler can be controlled to a contact area which is 1 time to 20 times, more suitably 1.5 times to 10 times, and still more suitably 2 times to 5 times, larger than a contact area between fillers when using a spherical soft filler and a spherical hard filler in combination.

In the thermally conductive resin composition 1 according to the first embodiment of the present invention, in case that the soft filler 5 is a thin walled plate-like shape, a ratio of the thickness of the soft filler 5 to the maximum diameter of the main surface may be from 1 to 40, more preferably from 3 to 30, and still more preferably from 5 to 20. If the ratio is within the above range, the soft filler 5 is likely to be curved due to pressing by the hard filler 4, thus enabling an increase in contact area between the hard filler 4 and the soft filler 5. Therefore, it is possible to improve the thermal conductivity of the thermally conductive resin composition 1.

### [Thermally Conductive Filler]

The thermally conductive resin composition 1 according to the first embodiment of the present invention includes at least two or more kinds of fillers, each having a different Mohs hardness. It is necessary that the filler according to the present invention contains a hard filler 4 having a Mohs hardness of 5 or more and a soft filler 5 having a Mohs hardness of 3 or less, and that the thermally conductive resin composition 1 contains at least one hard filler 4 and soft filler 5. In case that the thermally conductive resin composition contains either one of the hard filler 4 and the soft filler 5, particle deformation is less likely to occur at a contact portion between filler particles in the thermally conductive resin composition, and the contact area between particles is small, thus failing to obtain a resin composition which exhibits satisfactory thermal conductivity. When using fillers in which the hard filler 4 and the soft filler 5 have a Mohs hardness which is outside the above range, it is also impossible to obtain a resin composition exhibiting satisfactory thermal conductivity for the same reason as that in the case of using only either one filler of the hard filler 4 and the soft filler 5.

As used herein, Mohs hardness indicates susceptibility to flaws against scratching. In the present invention, 10-level Mohs hardness (old Mohs hardness) is employed.

In the thermally conductive resin composition 1 according to the first embodiment of the present invention, any material may be used as a material composing the hard filler 4 as long as the Mohs hardness is 5 or more. Specific examples of the hard filler 4 include aluminum oxide, magnesium oxide, fused silica, crystalline silica, aluminum nitride, silicon nitride, silicon carbide and zinc oxide. Mohs hardnesses of these materials are as follows:

| | |
|---|---|
| Aluminum oxide | 9 |
| Magnesium oxide | 6 |
| Fused silica | 7 |
| Crystalline silica | 7 |
| Aluminum nitride | 7 |
| Silicon nitride | 9 |
| Silicon carbide | 9 |
| Zinc oxide | 4 to 5 |

It is preferred to use, as magnesium oxide to be used as the hard filler 4 in the present invention, magnesium oxide having low surface activity produced by a dead burning method so as to prevent hydrolysis due to moisture. Light burned magnesia is burned at 1,200° C. or lower during preparation, while dead burned magnesia is burned at high temperature of 1,500° C. or higher and thus it has less pores and low surface activity, leading to satisfactory moisture resistance.

In a thermally conductive resin composition 1 according to a first embodiment of the present invention, any material may be used as a material composing the soft filler 5 as long as the Mohs hardness is 3 or less. Specific examples of the soft filler 5 include diatomaceous earth, boron nitride, aluminum hydroxide, magnesium hydroxide, magnesium carbonate, calcium carbonate, talc, kaolin, clay and mica. Mohs hardnesses of these materials are as follows:

| | |
|---|---|
| Diatomaceous earth | 1 to 1.5 |
| Boron nitride | 2 |
| Aluminum hydroxide | 2.5 |
| Magnesium hydroxide | 2.5 |
| Magnesium carbonate | 3.5 to 4.5 |
| Calcium carbonate | 3 |
| Talc | 1 |
| Kaolin | 1 to 2 |
| Clay | 2.5 to 3 |
| Mica | 2.5 to 3 |

If these materials are selected as the hard filler 4 or the soft filler 5, deformation of the soft filler 5 occurs at a contact portion 10 between the hard filler 4 and the soft filler 5 in the thermally conductive resin composition 1, and the contact area between particles increases, thus making it possible to obtain a resin composition exhibiting satisfactory thermal conductivity. Therefore, these materials can be suitably used.

There is no particular limitation on the shape of the hard filler 4, and a spherical shape or a polyhedral shape is desired. The soft filler 5 may have a shape such as a scaly shape, a lamellar shape, a flaky shape, or a plate-like shape. For example, in case that the spherical hard filler 4 is contacted with the scaly soft filler 5 in a binder resin 3, a contact area of the particle interface increases as compared with the case where spherical fillers are contacted with each other, and thus it becomes possible to obtain a thermally conductive resin composition having satisfactory thermal conductivity. There is no particular limitation on the particle diameter (median diameter: d50) of fillers 4 and 5 of the present invention, and the particle diameter may be from 5 to 200 μm.

In the thermally conductive resin composition according to the present invention, it is also a preferred aspect to use, as the hard filler 4, an irregularly shaped filler having irregular projection/recess on a surface. Use of the irregularly shaped filler as the hard filler 4 enables an increase in contact points between the hard filler 4 and the soft filler 5 or contact points between hard fillers 4, leading to an increase in thermal conduction paths. Therefore, the thermal conductivity is high regardless of a small filling amount of the thermally conductive filler (that is, hard filler 4 and soft filler 5). Such small filling amount of the thermally conductive filler ensures the fluidity of the thermally conductive resin composition, leading to an improvement in moldability.

The irregularly shaped filler may have a median diameter of 60 to 120 μm, and may have a specific surface area of 0.1 m²/g or more. The median diameter of the irregularly shaped filler of 60 to 120 μm enables an improvement in fluidity when using the irregularly shaped filler in combination with a soft filler.

Since the specific surface area of the irregularly shaped filler of 0.1 m²/g or more enables the formation of significant projection/recess of a surface of the irregularly shaped filler surface, the number of contact points between the hard filler 4 and the soft filler 5 or the number of contact points between hard fillers 4 efficiently increases, leading to effective increase in thermal conduction paths.

As long as the irregularly shaped filler is as mentioned above, a production method thereof may be any method and, for example, the following method is suitably used.

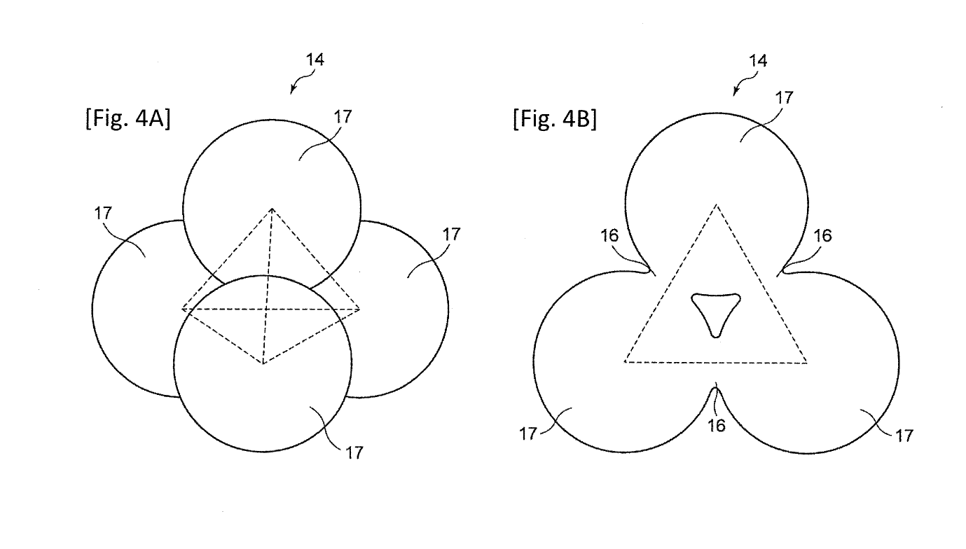

A description will be made in detail on the shape of an example of the irregularly shaped filler (hereinafter may be sometimes referred to as an irregularly shaped filler 14) to be contained as the hard filler 4. Describing conceptually about the case where the irregularly shaped filler 14 is composed of four thermally conductive filler particles 17 as primary particles, as shown in FIGS. 4A and 4B, these four thermally conductive filler particles 17 locate at each apex of an approximately tetrahedron, and each thermally conductive filler particle 17 is welded with each other thermally conductive filler particle 17 to form a neck-shaped welded portion 16 in the vicinity of an intermediate portion of the apex of the approximately tetrahedron. As shown in FIG. 4B, a gap is formed between surfaces of the thermally conductive filler particles 17. Usually, the irregularly shaped filler 14 is composed of four or more numerous thermally conductive fillers 17. In this way, even if the irregularly shaped filler 14 is composed of plural thermally conductive fillers 17, similar to the case where the irregularly shaped filler 14 is composed of four thermally conductive filler particles 17 as mentioned above, at least a part of numerous thermally conductive fillers 17 are welded with the other thermally conductive filler 17, whereby, a neck-shaped welded portion 16 is formed between these thermally conductive fillers 17, and plural gaps are formed between surfaces of numerous thermally conductive fillers 17, and thus the neck-shaped welded portions 16 or gaps are formed over the irregularly shaped filler 14, approximately uniformly. There is no need to form the neck-shaped welded portion 16 or gap over the irregularly shaped filler 14, and may be formed on at least a portion thereof. It is preferred that the welded portion 16 or gap is uniformly present in the irregularly shaped filler 14. However, there is no need to uniformly exist, necessarily. In this way, the thermally conductive fillers 17 are partially welded with each other, and thus irregular projection/recess is formed on a surface of the irregularly shaped filler 14.

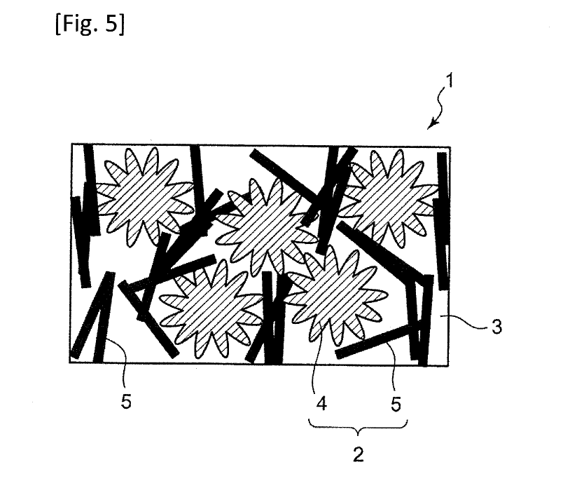

In this way, plural thermally conductive filler particles 17 are partially welded with each other, and thus plural neck-shaped welded portions 16 are formed in a remote location, and gaps 8 are formed between the thermally conductive filler particle 17 and the thermally conductive filler particle 17, and also irregular projection/recess is formed on a surface of the irregularly shaped filler 14, whereby, a surface area increases as compared with a spherical or crushed conventional filler. Therefore, as shown in FIG. 5, numerous contact points between thermally conductive filler particles 17 are formed, thus enabling effective improvement in thermal conductivity as compared with the spherical or crushed conventional filler. Furthermore, when using in combination with a soft filler, the number of contact points is increased by increasing the content of the thermally conductive filler while maintaining moldability of a molding, obtained by curing a thermally conductive resin composition, thus enabling realization of higher thermal conduction.

### [Content Ratio and Content of Fillers]

The thermally conductive resin composition 1 of the present invention contains, in a binder resin 3, 50% by volume or more and less than 95% by volume of a thermally conductive filler 2 (hard filler 4 and soft filler 5). If the content of the thermally conductive filler 2 is less than 50% by volume, it is impossible to expect the effect of improving the thermal conductivity of a thermally conductive resin composition 1 due to mixing of the thermally conductive filler 2. If the content is 95% by volume or more, the viscosity of the thermally conductive resin composition 1 may excessively increase, leading to rapid deterioration of the moldability.

A ratio of the hard filler 4 and the soft filler 5 contained in a binder resin 3 may be within a range from 95:5 to 50:50, as shown in the following equation (1).

Hard filler 4/soft filler 5=95/5 to 50/50 (1)

If the ratio of the hard filler 4 and the soft filler 5 deviates from the above range leading to a small proportion of the soft filler 5, the contact area between particles decreases because of less fillers which cause particle deformation, and thus it may be impossible to obtain sufficient effect of improving the thermal conductivity. If the proportion of the soft filler 5 is small, deformation of the soft filler 5 due to the hard filler 4 does not sufficiently occur, and thus it may be impossible to obtain sufficient effect of improving the thermal conductivity. If the proportions of the hard filler 4 and the soft filler 5 fall within the above range, the thermally conductive resin composition 1 can obtain high thermal conductivity.

### [Surface Treatment]

In the thermally conductive resin composition 1 according to the present invention, in order to improve compatibility between the thermally conductive filler 2 and binder resin 3, the thermally conductive filler 2 may be subjected to a surface treatment such as a coupling treatment, or a dispersant may be added to improve the dispersibility in the thermally conductive resin composition 1. Plural kinds of fillers may be used in combination within the above proportion as long as they satisfy the above Mohs hardness.

In such surface treatment, it is possible to use an organic surface treatment agent such as fatty acid, fatty acid ester, higher alcohol, or hydrogenated oil; or an inorganic surface treatment agent such as silicone oil, silane coupling agent, alkoxysilane compound, or silylation agent. Use of these surface treatment agents may cause an improvement in water resistance of the thermally conductive filler 2, and may cause an improvement in dispersibility of the thermally conductive filler 2 in the binder resin 3. There is no particular limitation on treatment method, and examples thereof include (1) a dry method, (2) a wet method, (3) an integral blend method, and the like. These treatment methods will be described below.

### (1) Dry Method

The dry method is a method in which a surface treatment is performed by adding dropwise a chemical while stirring a filler by mechanical stirring using a Henschel mixer, a Nautamixer, or a vibrating mill. Examples of the form of the chemical include a solution prepared by diluting an inorganic surface treatment agent with an alcohol solvent, a solution prepared by diluting an inorganic surface treatment agent with an alcohol solvent and further adding water, a solution prepared by diluting an inorganic surface treatment agent with an alcohol solvent and further water and an acid, and the like. The method for preparing a chemical is disclosed in a catalog of a manufacturing company of a silane coupling agent, and is decided depending on a hydrolysis rate of an inorganic surface treatment agent, or kinds of a thermally conductive inorganic filler.

### (2) Wet Method

The wet method is a method in which a surface treatment is performed by directly immersing a filler in a chemical. Examples of the form of the chemical include a solution prepared by diluting an inorganic surface treatment agent with an alcohol solvent, a solution prepared by diluting inorganic surface treatment agent with an alcohol solvent and further adding water, a solution prepared by diluting inorganic surface treatment agent with an alcohol solvent and further water and an acid, and the like. The method for preparing a chemical is decided depending on a hydrolysis rate of an inorganic surface treatment agent, or kinds of a thermally conductive inorganic filler.

### (3) Integral Blend Method

The integral blend method is a method in which, when a resin is mixed with a filler, an inorganic surface treatment agent is directly added in a mixer in the form of an undiluted solution or a solution diluted with an alcohol, followed by stirring. The method for preparing a chemical is the same as those of the dry method and the wet method. In case that the surface treatment is performed by the integral blend method, the amount of the inorganic surface treatment agent is generally increased as compared with the above-mentioned dry method and wet method.

In the dry method and the wet method, a chemical is appropriately dried, as needed. In case that a chemical using an alcohol is added, the alcohol must be vaporized. If the alcohol finally remains in the blend, the alcohol generates from the product in the form of a gas and exerts an adverse influence on the polymer component. Therefore, the drying temperature may be controlled to a boiling point of a solvent or higher. In order to quickly remove the inorganic surface treatment agent which did not react with the thermally conductive inorganic powder, heating may be performed to reach high temperature (for example, 100° C. to 150° C.) using a device. Taking heat resistance of the inorganic surface treatment agent into consideration, treatment temperature may be maintained at a temperature lower than the decomposition point of silane. The treatment temperature may be from about 80 to 150° C., and the treatment time may be from 0.5 to 4 hours. It also becomes possible to remove the solvent or the unreacted inorganic surface treatment agent by appropriately selecting the drying temperature and the drying time depending on the treatment amount.

The amount of the inorganic surface treatment agent, which is needed to treat a surface of a thermally conductive filler 2, can be calculated by the following equation.

Amount of inorganic surface treatment agent (g)=[amount of thermally conductive inorganic filler (g)]×[specific surface area (m²/g) of thermally conductive inorganic filler]/[minimum coating area (m²/g) of inorganic surface treatment agent]

It is possible to determined “minimum coating area of inorganic surface treatment agent” by the following equation.

Minimum coating area (m²/g) of inorganic surface treatment agent=(6.02×10²³)×(13×10⁻²⁰)/[molecular weight of inorganic surface treatment agent]

where
6.02×10²³: Avogadro's constant
13×10⁻²⁰: area (0.13 nm²) covered with one molecule of inorganic surface treatment agent

The desired amount of an inorganic surface treatment agent may be 0.5 times or more and less than 1.0 times the amount of the inorganic surface treatment agent to be calculated by this calculation equation. If the upper limit is less than 1.0 times, it is possible to decrease the amount of the inorganic surface treatment agent, which actually exists on a surface of a thermally conductive inorganic powder, taking the amount of the unreacted filler into consideration. The reason why the lower limit was set at 0.5 time the amount to be calculated by the above calculation equation is that sufficient effect is exerted on an improvement in filling of a filler into a resin even if the amount is 0.5 time-amount.

### [Binder Resin]

There is no particular limitation on a binder resin 3 used in the present invention, and both a thermosetting resin and a thermoplastic resin can be used and these resins may be used in combination. From a viewpoint of capable of filling a thermally conductive filler 2 in higher density and exerting high effect of improving thermal conductivity, the thermosetting resin may be used.

Existing thermosetting resins can be used. In view of particularly excellent moldability and mechanical strength, it is possible to use an unsaturated polyester resin, an epoxy-based acrylate resin, an epoxy resin, and the like.

There is no particular limitation of kinds of the unsaturated polyester resin. The unsaturated polyester resin is composed, for example, of an unsaturated polybasic acid such as an unsaturated dicarboxylic acid (a saturated polybasic acid is optionally added), a polyhydric alcohol and a crosslinking agent such as styrene. An acid anhydride is also included in the unsaturated polybasic acid or saturated polybasic acid.

Examples of the unsaturated polybasic acid include unsaturated dibasic acids such as maleic anhydride, maleic acid, fumaric acid and itaconic acid. Examples of the saturated polybasic acid include saturated dibasic acids such as phthalic acid, phthalic anhydride, isophthalic acid, terephthalic acid, succinic acid, adipic acid and sebatic acid; and acids other than dibasic acids, such as benzoic acid and trimellitic acid.

Examples of the polyhydric alcohol include glycols such as ethylene glycol, propylene glycol, diethylene glycol, dipropylene glycol, neopentyl glycol, hydrogenated bisphenol A and 1,6-hexanediol.

It is possible to commonly use, as the crosslinking agent, an unsaturated monomer which is cross-linkable with a thermosetting resin which is a polycondensed product of an unsaturated polybasic acid with a polyhydric alcohol. There is no particular limitation on the unsaturated monomer and, it is possible to use, for example, a styrene-based monomer, vinyltoluene, vinyl acetate, diallyl phthalate, triallyl cyanurate, an acrylic acid ester and a methacrylic acid ester such as methyl methacrylate or ethyl methacrylate.

Typical examples of the unsaturated polyester resin include a maleic anhydride-propylene glycol-styrene-based resin, and the like.

A thermosetting resin can be obtained by reacting the above-mentioned unsaturated polybasic acid with a polyhydric alcohol through a polycondensation reaction, followed by radical polymerization of a crosslinking agent.

A known method can be used as a method for curing the unsaturated polyester resin and, for example, a curing agent such as a radical polymerization initiator may be added, and optional heating or irradiation with active energy rays. Existing curing agents can be used and examples thereof include peroxydicarbonates such as t-amylperoxy isopropyl carbonate; ketone peroxides, hydroperoxides, diacyl peroxides, peroxy ketals, dialkyl peroxides, peroxy esters, alkyl peresters, and the like. These curing agents may be used alone, or two or more kinds of them may be used in combination.

It is also possible to use, as the thermosetting resin used in the present invention, resins obtained by curing an epoxy-based acrylate resin, as mentioned above.

The epoxy-based acrylate resin is a resin having a functional group, which is polymerizable by a polymerization reaction, in an epoxy resin skeleton. The epoxy-based acrylate resin is a reaction product obtained by ring-opening addition of a monoester of an unsaturated monobasic acid such as acrylic acid or methacrylic acid, or an unsaturated dibasic acid such as maleic acid or fumaric acid, to one epoxy group of an epoxy resin having two or more epoxy groups in a molecule. Usually, this reaction product is in a state of a liquid resin by a diluent. Examples of the diluent include radical-polymerization reactive monomers such as styrene, methyl methacrylate, ethylene glycol dimethacrylate, vinyl acetate, diallyl phthalate, triallyl cyanurate, acrylic acid ester and methacrylic acid ester.

Herein, existing epoxy resins can be used as the epoxy resin skeleton and specific examples thereof include a bisphenol type epoxy resin such as a bisphenol A type epoxy resin, a bisphenol F type epoxy resin, or a bisphenol S type epoxy resin, which is synthesized from bisphenol A, bisphenol F or bisphenol S and epichlorohydrin; a phenol novolak type epoxy resin which is synthesized from a so-called phenol novolak resin obtained by reacting phenol with formaldehyde in the presence of an acidic catalyst and epichlorohydrin; and a novolak epoxy resin such as a cresol novolak type epoxy resin which is synthesized from a so-called cresol novolak resin obtained by reacting cresol with formaldehyde in the presence of an acidic catalyst and epichlorohydrin.

Curing can be performed in the same manner as in the unsaturated polyester resin, and a cured article of an epoxy-based acrylate resin can be obtained by using the same curing agent as mentioned above.

In this case, the thermosetting resin to be used may be obtained by curing an unsaturated polyester resin or an epoxy-based acrylate resin, or may be obtained by curing the mixture of both resins. Resins other than these resins may also be contained.

When using an epoxy resin, it is possible to use a bisphenol A type epoxy resin, a bisphenol F type epoxy resin, a bisphenol S type epoxy resin, a biphenyl type epoxy resin, a naphthalenediol type epoxy resin, a phenol novolak type epoxy resin, a cresol novolak type epoxy resin, a bisphenol A novolak type epoxy resin, a cyclic aliphatic epoxy resin, a heterocyclic epoxy resin (triglycidyl isocyanurate, diglycidyl hydantoin, etc.) and modified epoxy resins obtained by modifying these resins with various materials.

It is also possible to use halides such as bromide and chloride of these resins. It is also possible to appropriately use two or more kinds of these resins in combination.

It is preferred to use a phenol novolak type epoxy resin, a cresol novolak type epoxy resin or a bisphenol A novolak type epoxy resin, or halides thereof since it is possible to impart high heat resistance and reliability, which can be used for applications of electrical and electronic materials, to an insulating layer.

Existing curing agents such as phenol-based, amine-based and cyanate-based compounds can be used alone or in combination, as the curing agent.

Specific examples thereof include phenol-based curing agents having a phenolic hydroxyl group, such as phenol novolak, cresol novolak, bisphenol A, bisphenol F, bisphenol S and melamine-modified novolak type phenol resins; or halogenated curing agents thereof; and amine-based curing agents such as dicyandiamide.

It is possible to use, as the thermoplastic resin, a polyolefin-based resin, a polyamide-based resin, an elastomer-based (styrene-based, olefin-based, polyvinyl chloride(PVC)-based, urethane-based, ester-based, or amide-based) resin, an acrylic resin, a polyester-based resin, an engineering plastic, and the like. In particular, resins to be selected are polyethylene, polypropylene, a nylon resin, an acrylonitrile-butadiene-styrene (ABS) resin, an acrylic resin, an ethylene acrylate resin, an ethylene-vinyl acetate resin, a polystyrene resin, a polyphenylene sulfide resin, a polycarbonate resin, a polyester elastomer resin, a polyamide elastomer resin, a liquid crystal polymer, a polybutylene terephthalate resin, and the like. Of these resin, a nylon resin, a polystyrene resin, a polyester elastomer resin, a polyamide elastomer resin, an ABS resin, a polypropylene resin, a polyphenylene sulfide resin, a liquid crystal polymer and a polybutylene terephthalate resin may be used in view of heat resistance and flexibility.

As long as the effects of the present invention are not impaired, the thermally conductive resin composition 1 of the present invention may contain a fiber reinforcer, a shrinkage diminishing agent, a thickener, a colorant, a flame retardant, an auxiliary flame retardant, a polymerization inhibitor, a polymerization delaying agent, a curing accelerator, a viscosity reducing agent for the adjustment of a viscosity during production, a dispersion control agent for the improvement of dispersibility of a toner (colorant), a mold releasant, and the like. It is possible to use existing additives and examples thereof include the followings.

Inorganic fibers such as glass fibers and various organic fibers can be used as the fiber reinforcer. Sufficient reinforcing effect or moldability can be obtained when the fiber length is, for example, from about 0.2 to 30 mm.

It is possible to use, as the shrinkage diminishing agent, polystyrene, polymethyl methacrylate, cellulose acetate butyrate, polycaprolactane, polyvinyl acetate, polyethylene, polyvinyl chloride, and the like. These shrinkage diminishing agents may be used alone, or two or more kinds of them may be used in combination.

It is possible to use, as the thickener, light-burned MgO (produced by a light burning method), Mg(OH)₂, Ca(OH)₂, CaO, tolylene diisocyanate, diphenylmethane diisocyanate, and the like. These thickeners may be used alone, or two or more kinds of them may be used in combination.

It is possible to use, as the colorant, for example, inorganic pigments such as titanium oxide; organic pigments; or toners containing them as main components. These colorants may be used alone, or two or more kinds of them may be used in combination.

Examples of the flame retardant include an organic flame retardant, an inorganic flame retardant, a reactive system flame retardant, and the like. Two or more kinds of these flame retardants can be used in combination. In case that the thermally conductive resin composition 1 of the present invention is allowed to contain a flame retardant, an auxiliary flame retardant may be used in combination. Examples of the auxiliary flame retardant include antimony compounds such as diantimony trioxide, diantimony tetraoxide, diantimony pentoxide, sodium antimonate, and antimony tartrate; zinc borate, barium metaborate, hydrated alumina, zirconium hydroxide, ammonium phosphate, tin oxide, iron oxide, and the like. These auxiliary flame retardants may be used alone, or two or more kinds of them may be used in combination.

It is possible to use, as the mold releasant, for example, stearic acid, and the like.

### [Method for Producing Thermally Conductive Resin Composition]

The method for producing a thermally conductive resin composition of the present invention will be described in detail below. A production method using a thermosetting resin will be described in detail below as an example.

The respective raw materials, fillers, and thermosetting resins needed to produce a thermally conductive resin composition are blended in predetermined proportions, and mixed by a mixer, a blender, or the like, and then the mixture is kneaded by a kneader, a roll, or the like, to obtain a thermosetting resin composition (hereinafter referred to as a compound) in an uncured state. After preparing separable upper and lower molds capable of imparting the objective molding shape, the compound was injected into the molds in the desired amount, followed by heating under pressure. After opening the molds, the objective molded product can be removed. It is possible to appropriately select the molding temperature, molding pressure, and the like, depending on the shape of the objective molded article.

It is also possible to produce a complex of a thermally conductive resin composition and metal by covering a surface of a mold with a metal foil or a metal plate in the case of charging a compound, placing the compound in the mold covered with the metal foil or the like, followed by heating under pressure.

The molding conditions vary depending on kinds of the thermosetting resin composition and are not particularly limited. For example, molding can be performed under a molding pressure of 3 to 30 MPa at a molding temperature of 120 to 150° C. for 3 to 10 minutes (molding time). Various existing molding methods can be used as the molding method and, for example, compression molding (direct pressure molding), transfer molding, injection molding, and the like can be used.

The thermally conductive resin composition obtained in the way mentioned above exhibits larger contact area between fillers than that of a thermally conductive resin composition using an existing fillers, and thus making it possible to efficiently realize high thermal conduction. Since the content of the filler can be decreased, fluidity of the thermally conductive resin composition is improved, and thus resulting in satisfactory moldability of the thermally conductive resin composition.

### [Glass Transition Temperature Tg]

A glass transition temperature Tg of a binder resin 3 may be preferably within a range from 60° C. to 200° C., and more preferably from 90° C. to 180° C. If the glass transition temperature Tg of the binder resin 3 is lower than 60° C., the binder resin 3 may sometimes undergo heat deterioration. If the glass transition temperature Tg of the binder resin 3 is higher than 200° C., compatibility between the binder resin 3 and the other resin may become worse, leading to deterioration of heat resistance of the thermally conductive resin composition.

### [Thermal Conductivity]

The hard filler 4 and the soft filler 5 may have thermal conductivity of 2 W/m·K or more. If the hard filler 4 and the soft filler 5 have thermal conductivity of 2 W/m·K or more, it is possible to further enhance thermal conductivity of the cured thermally conductive resin composition (molding). The lower value of the thermal conductivity of the hard filler 4 and the soft filler 5 may be more preferably 5 W/m·K or more, and still more preferably 10 W/m·K or more. There is no particular limitation on the upper limit of thermal conductivity of the hard filler 4 and the soft filler 5. An inorganic filler having thermal conductivity of about 300 W/m·K or more has been well known, and also an inorganic filler having thermal conductivity of about 200 W/m·K or more is easily available.

### [Particle Diameter]

Spherical hard filler 4 and soft filler 5 may have an average particle diameter (median diameter: d50) within a range from 5 to 200 μm. If the average particle diameter (median diameter: d50) of the hard filler 4 and the soft filler 5 is less than 5 μm, it may become difficult to fill with spherical fillers 4, 5 in high density. If the average particle diameter (median diameter: d50) of the hard filler 4 and the soft filler 5 is more than 200 μm, dielectric breakdown properties of a cured thermally conductive resin composition (molding) may sometimes deteriorate. As used herein, “average particle diameter” refers to a median diameter (d50). The median diameter means a particle diameter (d50) in which cumulative weight percentage reaches 50%, and can be measured using a laser diffraction particle size distribution analyzer “SALD2000” (manufactured by Shimadzu Corporation).

When magnesium oxide is used as the hard filler 4, it is preferred to mix two kinds of magnesium oxides each having a different median diameter. In this way, mixing of those, each having a different median diameter, enables suppression of an increase in viscosity of the resin, and thus a large amount of the inorganic filler can be mixed in the resin. For example, it is preferred to mix those, each having a median diameter ranging from 200 to 30 μm (preferably from 150 to 50 μm), with those, each having a median diameter ranging from 20 to 1 μm (preferably from 10 to 5 μm). A mixing ratio (by mass) thereof is preferably from 90:10 to 10:90, and more preferably from 70:30 to 30:70.

### (Other Additives)

The thermally conductive resin composition of the present invention may be mixed with fillers other than the above-mentioned hard and soft fillers, heat stabilizers, antioxidants, ultraviolet absorbers, age resistors, plasticizers, antibacterials, and the like depending on the intended purposes and uses.

It is possible to use, as the above-mentioned heat stabilizer, metal alkoxides mentioned below.

Specific examples of the metal alkoxide include substituted or non-substituted alkoxysilanes, such as tetramethoxysilane, tetraethoxysilane, tetra-n-propoxysilane, tetraisopropoxysilane, tetra-n-butoxysilane, and tetrakis(2-methoxyethoxy)silane; and

substituted or non-substituted aluminum alkoxides, such as aluminum triethoxide, aluminum tri-n-propoxide, aluminum triisopropoxide, aluminum tri-n-butoxide, aluminum triisobutoxide, aluminum tri-sec-butoxide, aluminum tri-tert-butoxide, aluminum tris(hexyloxide), aluminum tris(2-ethylhexyloxide), aluminum tris(2-methoxyethoxide), aluminum tris(2-ethoxyethoxide), and aluminum tris(2-butoxyethoxide).

### [Light Emitting Device]

An LED light emitting device according to the present embodiment will be described.

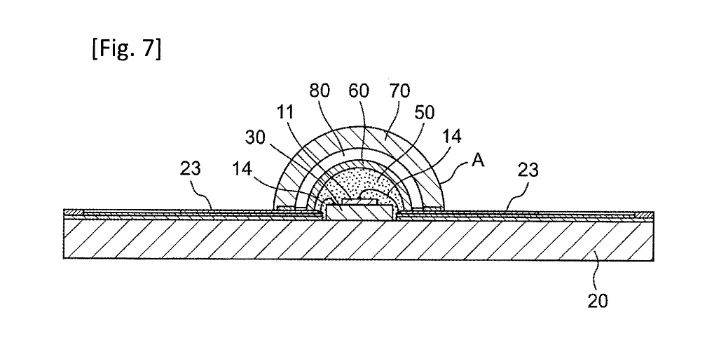

FIG. 7 shows an example of an LED light emitting device in which a thermally conductive resin composition 1 according to the present invention is used as a resin for a mounted substrate 20. In this way, use of the thermally conductive resin composition 1 according to the present invention as the mounted substrate 20 enables dissipation of heat generated from the LED light emitting device by the mounted substrate 20 made of the thermally conductive resin composition 1, thus enabling suppression of a temperature rise of the LED light emitting device.

In the LED light emitting device according to the present embodiment, an LED chip 11 is mounted on a surface of a mounted substrate 20 with a conductor pattern 23 formed thereon via submount member 30 for stress relaxation, and the LED chip 11 is connected to the conductor pattern 23 through a wire 14. A dome-shaped optical member 60 made of a translucent material is attached to a surface of the mounted substrate 20 so as to surround the LED chip 11, so that distribution of light emitted from the LED chip 11 is controlled by the optical member 60. A translucent sealing material 50 for sealing the LED chip 11 and the bonding wire 14 is filled inside the optical member 60. Furthermore, a dome-shaped wavelength conversion member 70 is attached to the mounted substrate 20 so as to cover the optical member 60 via a space 80. The wavelength conversion member 70 is formed by dispersing a phosphor A of the present invention in a translucent sealing medium (for example, silicone resin, etc.).

In the LED light emitting device formed as mentioned above, for example, it is possible to use, as the LED chip 11, a GaN-based blue LED chip which emits blue light, and to use, as phosphor to be dispersed in the wavelength conversion member 70, green phosphor particles which are excited by light emitted from the LED chip 11 to emit green light, and red phosphor particles which are excited by light emitted from the LED chip 11 to emit red light. If the LED chip 11 is made to emit light, thus emitting blue light, in case that the light penetrates the wavelength conversion member 70, blue light is partially converted into green light by green phosphor particles and also remaining blue light is partially converted into red light by red phosphor particles, and thus the blue light, the green light and the red light are mixed and emitted from an LED light emitting device A as white light. Therefore, it is possible to use the LED light emitting device A as an illumination device which emits white light.

A first aspect of the present invention is a thermally conductive resin composition, including:

a thermally conductive filler; and

a binder resin, wherein

the thermally conductive filler contains a hard filler having a Mohs hardness of 5 or more and a soft filler having a Mohs hardness of 3 or less, and wherein

when the thermally conductive resin composition is solidified to stabilize the shape, a surface of the soft filler is deformed in a state where the soft filler is pressed against the hard filler in a solidified thermally conductive resin composition, leading to face contact between the soft filler and the hard filler.

A second aspect of the present invention is the thermally conductive resin composition according to the first aspect, wherein the hard filler may be at least one selected from the group consisting of aluminum oxide, magnesium oxide, fused silica, crystalline silica, aluminum nitride, silicon nitride, silicon carbide and zinc oxide.

A third aspect of the present invention is the thermally conductive resin composition according to the first or second aspect, wherein the soft filler may be at least one selected from the group consisting of diatomaceous earth, boron nitride, aluminum hydroxide, magnesium hydroxide, magnesium carbonate, calcium carbonate, talc, kaolin, clay and mica.

A fourth aspect of the present invention is the thermally conductive resin composition according to any one of the first to third aspects, wherein the soft filler suitably has a scaly shape, a lamellar shape, a flaky shape or a plate-like shape.

A fifth aspect of the present invention is the thermally conductive resin composition according to any one of the first to fourth aspects, wherein the total content of the hard filler and the soft filler may be 50% by volume or more and less than 95% by volume based on the whole thermally conductive resin composition.

A sixth aspect of the present invention is the thermally conductive resin composition according to any one of the first to fifth aspects, wherein a volume ratio of the hard filler to the soft filler may be within a range of the following equation (1).

Hard filler/soft filler=95/5 to 50/50 (1)

A seventh aspect of the present invention is a thermally conductive molding obtained by molding the thermally conductive resin composition according to any one of the first to sixth aspects, wherein a surface of the soft filler is deformed in a state where the soft filler is pressed against the hard filler in the thermally conductive resin composition to provide a face contact between the soft filler and the hard filler.

### EXAMPLES

### Evaluation Methods

### 1. Evaluation of Particle Diameter of Inorganic Filler

An average particle diameter (median diameter: d50) of a filler was measured using a laser diffraction particle size distribution analyzer “SALD2000” (manufactured by Shimadzu Corporation).

### 2. Confirmation of State of Filler in Cured Thermally Conductive Resin Composition (Molding)

A cured thermally conductive resin composition (molding) was cut by focused ion beam (FIB) processing, and a cross section thereof was observed by a backscattered electron image using an electron microscopy (SEM) and then a state of contact between inorganic fillers in the resin was confirmed. Qualitative analysis of the kind of the contacted inorganic filler was performed from EDX analysis.

### 3-1. Quantitative Determination of Volume Ratio of Inorganic Filler in Cured Thermally Conductive Resin Composition (Molding)

Using an X-ray photoelectron spectroscope (ESCALAB220-XL, manufactured by Thermo Fisher Scientific Inc.), analysis was performed by irradiating an analysis area of 1 mm square of a cured thermally conductive resin composition (molding) with X-rays. Regarding analysis in a depth direction, analysis in a deep portion was performed after machining a surface of each specimen by sputtering through argon ion irradiation, followed by calculation of element concentration (atomic %) derived from an inorganic filler contained in the molding at a specific depth.

A weight ratio and a volume ratio (inorganic hard filler 4/inorganic soft filler 5) in the cured thermally conductive resin composition (molding) were calculated from the element concentration ratio derived from an inorganic hard filler 4 and an inorganic soft filler 5 calculated by an X-ray photoelectron spectroscope and a density of each inorganic filler. In the calculation of the volume ratio, the following values were used as the density of each filler.

| | |
|---|---|
| Magnesium oxide | 3.6 |
| Aluminum oxide | 4.0 |
| Aluminum hydroxide | 2.4 |
| Boron nitride | 2.2 |

### 3-2. Quantitative Determination of Content of Inorganic Filler in Cured Thermally Conductive Resin Composition (Molding)

A molding obtained by curing a thermally conductive resin composition was cut into a test piece having a predetermined shape and then the volume was calculated by the Archimedean method. Then, the molding was burned at 625° C. using a muffle furnace and the weight of the remaining ash was measured. Since the ash is an inorganic filler, a total volume ratio of the filler contained in the thermally conductive resin composition was calculated from the volume ratio calculated above of the filler, and a density of each filler.

In the calculation of the total volume ratio, the following values were used as the density of each filler.

| | |
|---|---|
| Magnesium oxide | 3.6 |
| Aluminum oxide | 4.0 |
| Aluminum hydroxide | 2.4 |
| Boron nitride | 2.2 |

### 4. Measurement of Thermal Conductivity

Samples, each measuring 10 mm square and 2 mm in thickness, were cut from the thermally conductive resin composition. Using a Xenon flash thermal conductivity analyzer LFA 447 manufactured by NETZSCH, the measurement was performed at 25° C.

### 5. Evaluation of Moldability

From a molding state of a plate-like test piece of a mold opening measuring 300 mm and 2.5 mm in thickness, moldability was visually judged according to the following criteria.

A: Molding could be performed without observing molding defects.
B: Molding could be performed, but molding defects were partially observed.
C: Molding could not be performed due to short shot.

### Production Example 1

In the preparation of a compound, the following resin and inorganic fillers were used.

Epoxy-based acrylate resin: (NEOPOL 8250H, manufactured by Japan U-Pica Company Ltd.)
Magnesium oxide having a median diameter of 90 μm (Irregular shape: specific surface area of 0.2 m²/g)
Magnesium oxide having a median diameter of 5 μm (Spherical shape: specific surface area of 2.2 m²/g)
Boron nitride having a median diameter of 8.5 μm (Spherical shape: specific surface area of 4.0 m²/g)
Aluminum hydroxide having a median diameter of 35 μm (Spherical shape: specific surface area of 2.0 m²/g)
Aluminum oxide having a median diameter of 30 μm (Spherical shape: specific surface area of 1.7 m²/g)
Mica having a median diameter of 30 μm (Spherical shape: specific surface area of 3.2 m²/g)

The above magnesium oxide is produced by a dead burning method.

### <Preparation of Compound>

To an epoxy-based acrylate resin, a diluent, a mold releasant, a curing catalyst, a polymerization inhibitor, and a viscosity modifier were added in each predetermined amount (parts by mass), followed by stirring using T.K. homodisper manufactured by PRIMIX Corporation to prepare a resin solution. In a pressure kneader (TD3-10MDX, manufactured by TOSHIN CO., LTD.), the resin solution prepared previously and a predetermined amount (parts by mass) of an inorganic filler were charged, followed by kneading under pressure for 20 minutes to prepare a compound. The mixing amount of the compound is shown in Table 1.

### <Production of Molding>

The compound prepared above was placed in upper and lower molds set at a mold temperature of 145° C., and then pressed under a molding pressure of 7 MPa at a mold temperature of 145° C. A molding time was set at 4 minutes. Whereby, an epoxy-based acrylate resin in the compound was melt-softened and deformed into a predetermined shape by heating, and then cured to obtain a molding of a thermally conductive resin composition.

### <Confirmation of State of Inorganic Filler in Cured Thermally Conductive Resin Composition (Molding)>

It was confirmed by observing a cross section of a cured thermally conductive resin composition (molding) using an electron microscopy (SEM) that a soft filler 5 is interposed between hard fillers 4 in moldings of a thermally conductive resin composition produced in Examples 1 to 3, and thermal conduction paths are formed by contacting with each other.

As shown in Table 2, samples containing a hard filler 4 having a Mohs hardness of 5 or more and a soft filler 5 having a Mohs hardness 3 or less of Examples 1 to 3 exhibited higher thermal conductivity and more satisfactory moldability as compared with samples having the same filler content of Comparative Examples 1 and 2. Samples containing a plate-like BN filler and mica as an inorganic hard filler 4 of Examples 1 and 3 exhibited higher thermal conductivity as compared with a sample containing a spherical Al(OH)₃ filler of Example 2.

TABLE 1
Table 1: Mixing amount in the preparation of compound

| | | | | | Comparative | Comparative |
|---|---|---|---|---|---|---|
| | | Example 1 | Example 2 | Example 3 | Example 1 | Example 2 |
| Thermosetting resin | Epoxy-based acrylate resin | 683 | 680 | 669 | 730 | 748 |
| Diluent | Styrene | 171 | 170 | 167 | 81 | 187 |
| Polymerization | p-Benzoquinone | 0.85 | 0.85 | 0.84 | 0.81 | 0.94 |
| inhibitor | | | | | | |
| Viscosity modifier | BYK9010 | 8.54 | 8.49 | 8.36 | 8.12 | 9.35 |
| Curing catalyst | t-Amylperoxyisopropyl | 8.54 | 8.49 | 8.36 | 8.12 | 9.35 |
| | carbonate | | | | | |
| Mold releasant | Zinc stearate | 34 | 34 | 33 | 32 | 37 |
| | Stearic acid | 11 | 11 | 11 | 11 | 12 |
| Inorganic filler | MgO (90 μm) | 3485 | 3466 | 3410 | 3895 | 3816 |
| | MgO (5 μm) | 2323 | 2310 | 2273 | 2597 | 2543 |
| | BN | 638 | | | | |
| | Al(OH)₃ | | 676 | | | |
| | Al₂O₃ | | | | | 1224 |
| | Mica | | | 783 | | |

TABLE 2
Table 2: Evaluation results of molded thermally conductive resin composition (molding)

| | Filler (B) | | | Filler (C) | | | Content ratio | Filler | Thermal | |
|---|---|---|---|---|---|---|---|---|---|---|
| | | | Mohs | | | Mohs | Filler (B)/ | content | conductivity | |
| | Type | Shape | hardness | Type | Shape | hardness | Filler (C) | (vol %) | (W/mK) | Moldability |
| Example 1 | MgO | Spherical | 6 | BN | Plate-like | 2 | 85/15 | 67 | 7.5 | A |
| | | shape | | | shape | | | | | |
| Example 2 | MgO | Spherical | 6 | Al(OH)₃ | Spherical | 2.5 | 85/15 | 67 | 6 | A |
| | | shape | | | shape | | | | | |
| Example 3 | MgO | Spherical | 6 | Mica | Plate-like | 2.5-3 | 85/15 | 67 | 6.5 | A |
| | | shape | | | shape | | | | | |
| Comparative | MgO | Spherical | 6 | — | — | — | 100/0 | 67 | 5 | C |
| Example 1 | | shape | | | | | | | | |
| Comparative | MgO | Spherical | 6 | Al₂O₃ | Spherical | 9 | 85/15 | 67 | 4 | C |
| Example 2 | | shape | | | shape | | | | | |

### Production Example 2

In the preparation of a compound, the following thermosetting resins, thermoplastic resin, diluent, polymerization inhibitor, viscosity modifier, curing agent, mold releasants and inorganic fillers were used.

### (Thermosetting Resin)

Epoxy-based acrylate resin (“NEOPOL 8250H”, manufactured by Japan U-Pica Company Ltd.)
Unsaturated polyester resin (“M-640LS”, manufactured by SHOWA HIGHPOLYMER CO., LTD.)

### (Thermosetting Resin)

Polystyrene resin (“MODIPER SV10B”, manufactured by NOF CORPORATION)

### (Diluent)

### Styrene

### (Polymerization Inhibitor)

p-Benzoquinone

### (Viscosity Modifier)

“BYK9010”, manufactured by BYK Japan KK

### (Curing Agent)

t-Amylperoxyisopropyl carbonate

### (Mold Releasant)

Zinc stearate
Stearic acid

### (Glass Fiber)

Chopped strand for BMC molding material reinforcer (“CS3E-227”, manufactured by Nitto Boseki Co., Ltd.)

### (Inorganic Filler)

Magnesium oxide having a median diameter of 90 μm (Irregular shape: specific surface area of 0.2 m²/g)
Magnesium oxide having a median diameter of 50 μm (Spherical shape: specific surface area of 0.4 m²/g)
Magnesium oxide having a median diameter of 5 μm (Spherical shape: specific surface area of 2.2 m²/g)
Boron nitride having a median diameter of 8.5 μm (Spherical shape: specific surface area of 4.0 m²/g)
Aluminum hydroxide having a median diameter of 35 μm (Spherical shape: specific surface area of 2.0 m²/g)
Aluminum oxide having a median diameter of 30 μm (Spherical shape: specific surface area of 1.7 m²/g)
Mica having a median diameter of 7.0 μm (Spherical shape: specific surface area of 3.2 m²/g)

The above magnesium oxides were produced by a dead burning method.

### <Preparation of Compound>

To a thermosetting resin, a thermoplastic resin, a diluent, a mold releasant, a curing catalyst, a polymerization inhibitor and a viscosity modifier were added in each predetermined amount (parts by mass), followed by stirring in a state where a pressure lid is opened using a pressure kneader (TD3-10MDX, manufactured by TOSHIN CO., LTD.) to prepare a resin solution. In that case, the thermosetting resin was dissolved in a diluent in advance and charged in a solution state. In the resin solution prepared previously, an inorganic filler and a flame retardant were charged in each predetermined amount (parts by mass), followed by kneading at 50 to 60° C. for 20 minutes and further charging of a predetermined amount (parts by mass) of a glass fiber and kneading at 20° C. for 5 minutes to prepare a compound. The mixing amount of the compound is shown in Table 1.

### <Production of Molding>

The compound prepared above was placed in upper and lower molds set at a mold temperature of 145° C., and then pressed under a molding pressure of 7 MPa at a mold temperature of 145° C. A molding time was set at 4 minutes. Whereby, a thermosetting resin in the compound was melt-softened and deformed into a predetermined shape by heating, and then cured to obtain a molding of the thermally conductive resin composition.

### <Confirmation of State of Inorganic Filler in Cured Thermally Conductive Resin Composition (Molding)>

It was confirmed by observing a cross section of a cured thermally conductive resin composition (molding) using an electron microscopy (SEM) that a soft filler 5 is interposed between hard fillers 4 in moldings of a thermally conductive resin composition produced in Examples 4 to 8 and thermal conduction paths are formed by contacting with each other.

As shown in Table 4, samples containing a hard filler 4 having a Mohs hardness of 5 or more and a soft filler 5 having a Mohs hardness 3 or less of Examples 4 to 8 exhibited higher thermal conductivity and more satisfactory moldability as compared with samples having the same filler content of Comparative Examples 3 and 4. Samples containing a plate-like BN filler and mica as an inorganic hard filler 4 of Examples 4 and 6 exhibited higher thermal conductivity as compared with a sample containing a spherical Al(OH)₃ filler of Example 5.

TABLE 3
Table 3: Mixing amount in the preparation of compound

| | | | | | | | Comparative | Comparative |
|---|---|---|---|---|---|---|---|---|
| | | Example 4 | Example 5 | Example 6 | Example 7 | Example 8 | Example 3 | Example 4 |
| Thermosetting | Unsaturated polyester | 140 | 138 | 134 | 140 | 138 | 126 | 124 |
| resin | Epoxy-based acrylate | 396 | 391 | 379 | 396 | 391 | 358 | 350 |
| | resin | | | | | | | |
| Thermoplastic | Polystyrene | 49 | 48 | 47 | 49 | 48 | 44 | 43 |
| resin | | | | | | | | |
| Diluent | Styrene | 114 | 113 | 109 | 114 | 113 | 103 | 101 |
| Polymerization | p-Benzoquinone | 0.24 | 0.24 | 0.23 | 0.24 | 0.24 | 0.22 | 0.21 |
| inhibitor | | | | | | | | |
| Viscosity modifier | BYK 9010 | 5.04 | 4.98 | 4.82 | 5.04 | 4.98 | 4.56 | 4.46 |
| Curing catalyst | t-Amylperoxyisopropyl | 13 | 12 | 12 | 13 | 12 | 11 | 11 |
| | carbonate | | | | | | | |
| Mold releasant | Zinc stearate | 20 | 20 | 19 | 20 | 20 | 18 | 18 |
| | Stearic acid | 59 | 58 | 56 | 59 | 58 | 53 | 52 |
| Inorganic filler | MgO (90 μm) | | | | 1597 | 1579 | | |
| | MgO (50 μm) | 1597 | 1579 | 1529 | | | 2197 | 1414 |
| | MgO (5 μm) | 1078 | 1066 | 1033 | 1078 | 1066 | 1477 | 954 |
| | BN | 860 | | | 860 | | | |
| | Al(OH)₃ | | 907 | | | 907 | | |
| | Mica | | | 1035 | | | | |
| | Al₂O₃ | | | | | | | 1335 |
| Flame retardant | Brominated epoxy | 159 | 157 | 152 | 159 | 157 | 144 | 140 |
| | Sb₂O₃ | 159 | 157 | 152 | 159 | 157 | 144 | 140 |
| Glass fiber | Chopped strand for | 353 | 349 | 338 | 353 | 349 | 319 | 312 |
| | BMC molding material | | | | | | | |
| | reinforcer | | | | | | | |

TABLE 4
Table 4: Evaluation results of molded thermally conductive resin composition (molding)

| | | | | | | | Content | | Thermal conductivity | | |
|---|---|---|---|---|---|---|---|---|---|---|---|
| | Filler (B) | | | Filler (C) | | | ratio | Filler | (W/mK) | | |
| | | | Mohs | | | Mohs | Filler (B)/ | content | Vertical | Horizontal | |
| | Type | Shape | hardness | Type | Shape | hardness | Filler (C) | (vol %) | direction | direction | Moldability |
| Example 4 | MgO | Spherical | 6 | BN | Plate-like | 2 | 66/34 | 52 | 2.8 | 4.7 | A |
| | | shape | | | shape | | | | | | |
| Example 5 | MgO | Spherical | 6 | Al(OH)₃ | Spherical | 2.5 | 66/34 | 52 | 2.8 | 2.8 | A |
| | | shape | | | shape | | | | | | |
| Example 6 | MgO | Spherical | 6 | Mica | Plate-like | 2.5-3 | 66/34 | 52 | 3.2 | 3.2 | A |
| | | shape | | | shape | | | | | | |
| Example 7 | MgO | Spherical | 6 | BN | Plate-like | 2 | 66/34 | 52 | 3.4 | 5.6 | A |
| | | shape + | | | shape | | | | | | |
| | | Irregular | | | | | | | | | |
| | | shape | | | | | | | | | |
| Example 8 | MgO | Spherical | 6 | Al(OH)₃ | Spherical | 2.5 | 66/34 | 52 | 3.2 | 3.2 | A |
| | | shape + | | | shape | | | | | | |
| | | Irregular | | | | | | | | | |
| | | shape | | | | | | | | | |
| Comparative | MgO | Spherical | 6 | — | — | — | 100/0 | 52 | 2 | 2 | B |
| Example 3 | | shape | | | | | | | | | |
| Comparative | MgO | Spherical | 6 | Al₂O₃ | Spherical | 9 | 66/34 | 52 | 1.7 | 1.7 | C |
| Example 4 | | shape | | | shape | | | | | | |

### DESCRIPTION OF REFERENCE SYMBOLS

1 Thermally conductive resin composition
2 Thermally conductive filler
3 Binder resin
4 Hard filler (Inorganic hard filler)
5 Soft filler (Inorganic soft filler)

1. A thermally conductive resin composition, comprising:
a thermally conductive filler; and
a binder resin,
wherein the thermally conductive filler contains:
a hard filler having a Mohs hardness of 5 or more; and
a scaly, lamellar, flaky or plate-like soft filler having a Mohs hardness of 3 or less, and
wherein the hard filler is at least one selected from the group consisting of aluminum oxide, magnesium oxide, fused silica, crystalline silica, aluminum nitride, silicon nitride, silicon carbide and zinc oxide, while the soft filler is boron nitride, and
wherein the binder resin contains either one or both of unsaturated polyester-based and epoxy-based acrylate resins.

2.-4. (canceled)

5. The thermally conductive resin composition according to claim 1, wherein the total content of the hard filler and the soft filler is 50% by volume or more and less than 95% by volume based on the whole thermally conductive resin composition.

6. The thermally conductive resin composition according to claim 1, wherein a volume ratio of the hard filler to the soft filler is within a range of the following equation (1),
Hard filler/soft filler=95/5 to 50/50 (1).

7. A thermally conductive molding obtained by molding the thermally conductive resin composition according to claim 1, wherein the soft filler is deformed in the thermally conductive resin composition to provide a face contact between the soft filler and the hard filler.

8. The thermally conductive resin composition according to claim 1, wherein the hard filler is magnesium oxide.

9. The thermally conductive resin composition according to claim 8, wherein the hard filler comprises first magnesium oxides, each having a median diameter ranging from 200 to 30 μm, and second magnesium oxides, each having a median diameter ranging from 20 to 1 μm, and
wherein a ratio by mass of the first magnesium oxides and the second magnesium oxides is from 70:30 to 30:70.

10. The thermally conductive resin composition according to claim 1, further comprising at least one flame retardant selected from the group consisting of brominated epoxy and antimony trioxide.
